(19) United States
(12) Patent Application Publication
(10) Pub. No.: US 2014/0044143 A1
(43) Pub. Date: Feb. 13, 2014

(54) LASER WITH A TAILORED AXIALLY SYMMETRIC PUMP BEAM PROFILE BY MODE CONVERSION A WAVEGUIDE

(71) Applicants: William Andrew Clarkson, Southampton (GB); Ji Won Kim, Ansan-si (KR); Jacob Isa Mackenzie, Southampton (GB)

(72) Inventors: William Andrew Clarkson, Southampton (GB); Ji Won Kim, Ansan-si (KR); Jacob Isa Mackenzie, Southampton (GB)

(21) Appl. No.: 14/113,950

(22) PCT Filed: Apr. 20, 2012
(86) PCT No.: PCT/GB2012/050868

§ 371 Date: Oct. 25, 2013

(30) Foreign Application Priority Data
Apr. 28, 2011 (GB) 1107129.7

(51) Int. Cl. H01S 3/063

(52) U.S. Cl. CPC H01S 3/063
USPC 372/72

(57) ABSTRACT

A laser device comprising a pump source (10) operable to generate a pump beam (11) for a resonant cavity in which a laser medium (74) is arranged. A beam-shaping waveguide element (18) is arranged between the pump source and the resonant cavity. Shaping of the pump beam is achieved by tailoring the refractive index profile of the waveguide element (18) so that it yields an intensity distribution which spatially overlaps a desired ring-shaped Laguerre-Gaussian mode of the resonant cavity sufficiently well to achieve laser oscillation on said desired Laguerre-Gaussian mode. A ring-shaped or doughnut-shaped laser beam profile can thus be generated. It is further possible to design the refractive index profile (76) so that the pump beam's intensity distribution also spatially overlaps the fundamental mode of the resonant cavity sufficiently well to achieve laser oscillation also on said fundamental mode. The laser will then lase on both the fundamental mode and the selected Laguerre-Gaussian mode. This is useful for producing a variety of beam profiles based on mixing a Gaussian profile with a ring-shaped profile. A top-hat beam profile can be achieved by such mixing.

### BACKGROUND OF THE INVENTION

The invention relates to lasers with axially-symmetric beam profiles.

Most lasers are designed to lase on the fundamental Hermite-Gaussian (HG) eigenmode mode of a resonant cavity, referred to as the TEM₀₀ mode, which provides a Gaussian beam profile.

However, the generation of high-quality ring-shaped laser beams is of significant commercial interest.

Over recent years the generation of ring-shaped (doughnut) beams has been the subject of much research and for which there are a variety of techniques available.

Beam-shaping schemes, such as axicons¹ or hollow-core fibres² can be used to provide a relatively straightforward route to a ring-shaped beam, typically at the expense of a significant degradation in beam quality and brightness, thus limiting their general applicability.

Lasers designed to lase on Laguerre-Gaussian (LG) resonator eigenmodes have also been developed in order to produce ring-shaped beam profiles.

Laser beams based on LG modes have been generated in a number of different ways which can be broadly sub-classified into designs in which the LG modes are generated external to a resonant laser cavity³⁻¹² and designs in which the LG modes are generated inside a resonant laser cavity¹³⁻²³.

Several known external methods for producing LG beams exploit the fact that LG modes can be formed by the superposition of correctly phased HG modes²⁴, alternatively a fundamental HG beam can be conditioned using polarization or phase modifications to force the appropriate conditions (e.g. radial or azimuthal polarization, or a helical phase front) as required for desired LG modes. A variety of approaches can be used, such as:
a cylindrical-lens mode converter³;
coherent combination such as a Mach-Zehnder interferometer⁴;
the introduction of an azimuthal phase dependence on the wavefronts of a fundamental Hermite-Gaussian beam using segmented or spiral phase plates⁵⁻⁷;
diffraction gratings produced by printing computer generated holograms^{8,9};
spatial light modulators^{10,11};
relief structures written onto an optical surface¹².

A disadvantage of the known external cavity methods is that additional optical components, typically with very precise alignment criteria, are required to achieve effective mode-conversion. The purity of the resulting LG mode is then dictated by quality of the phase control of the constituent modes, such as the resolution of the grating structure or phase converting element. Moreover scaling to high powers via this route is currently still quite challenging, particularly to produce efficient single higher-order mode TEM₀ₘ solid-state lasers, while for example in the case of spatial light modulation devices they can only be operated at modest power levels.

The known internal cavity methods for generating ring-shaped LG modes directly from a laser resonator exploit a variety of approaches:
inclusion of a cylindrical lens mode converter inside the laser resonator¹³
thermo-optical effects and the Guoy-phase shift in a bounce-geometry resonator¹⁴ (akin to the external mode-convertor³);
bi-refringence and stress-induced bi-focussing in cylindrical gain media¹⁵⁻¹⁷;
intra-cavity mode discriminating components such as apertures or Brewster axicons^{18, 19};
diffractive optical elements^{20, 21};
near-field diffraction effects of the pump radiation to provide an intensity null at the centre for micro-chip style gain media^{22, 23}.

All of these techniques, apart from references^{20, 21}, rely upon additional cavity components or pump-power dependent processes to enforce the right phase conditions to generate a ring-shaped LG mode. The approach of the authors of^{22, 23} effectively aimed to reduce the threshold condition for higher-order LG mode(s) with respect to the fundamental TEM₀₀ mode, but it is not an appropriate method for maintaining single higher order modes (HOMs) with increasing pump powers.

Another approach for generating doughnut-shaped beams relies on recent developments in specially designed optical fibre to propagate a single linearly polarized (LP) higher-order-mode (HOM)²⁵. The ring shaped high-order-modes have similar characteristics to LG modes²⁶. Extreme precision in the fabrication process is required to ensure exact cylindrical symmetry in the core to maintain the critical properties of the propagating mode, and ultimately the HOM fibres have limited power handling capabilities due to non-linear effects (such Stimulated Raman scattering) in the glass. Similar techniques have been also been demonstrated, using multi-mode fibres with polarization or wavelength selection of discrete HOM's in order to obtain ring-shaped and radial or azimuthal polarized beams²⁷⁻²⁹.

Laser beams propagating in Laguerre-Gaussian modes can be designated as LGₚ^{l} modes¹², where p and l are both integers. p+1 is the number of radial nodes and l relates to the azimuthal phase change. When p=l=0, the beam has a Gaussian transverse intensity profile. From an applications point of view, the family of Laguerre-Gaussian modes designated as LG₀^{l} (i.e. where p=0 and l>0) are of particular interest. These modes have a ring-shaped intensify profile and an intensity-null on the optical axis; they are not well matched for efficient operation when using uniform or near uniform pumping configurations, irrespective of the technique used to ensure their selection. This is purely a result of having no (or very little) stimulated emission from the excited volume along the beam axis. As such a high-purity higher-order LG mode can be difficult to generate in a power-scalable fashion as there are stringent requirements on discriminating against the fundamental TEM₀₀ mode, which typically has the lowest threshold condition due to its intensity peak on-axis and best overlap with the excitation volume of an optimised laser. As demonstrated by the authors of ^{22, 23}, tailoring the pump beam to provide an excitation region comparable to the desired output mode lends itself to simplified selection of single HOM's. The pump source configurations of^{22, 23} are limited to very short near field distances and therefore not suitable for generic gain media or power-scalable laser architectures.

### SUMMARY OF THE INVENTION

The invention is based on a conventional pump laser design with a pump source operable to generate a pump beam; a waveguiding element, such as a fibre, having a first end arranged to receive the pump beam and a second end to output the pump beam after traversing the waveguiding element; and a resonant cavity in which a laser medium is arranged to receive the pump beam output from the waveguiding element and which is operable to output a laser beam. The invention is based on the waveguiding element being specially designed to re-shape the pump beam in order to excite one or more desired Laguerre-Gaussian modes in the cavity. This is achieved by the waveguiding element having a refractive index profile such that the pump beam output from the waveguiding element has an intensity distribution which spatially overlaps, and thus preferentially excites one, or more than one, desired Laguerre-Gaussian mode LG₀^{l} of the resonant cavity. The waveguiding element is thus adapted to provide beam-shaping. The LG modes of primary interest are the ring-shaped modes which have an annular or ring-shaped intensity profile. Laser oscillation can thus be realised on one or more ring-shaped LG modes.

The beam-shaping waveguiding element can be tailored to provide an intensity distribution which spatially overlaps more than one desired Laguerre-Gaussian mode of the resonant cavity, in particular more than one ring-shaped Laguerre-Gaussian mode. The output laser beam will then still have a ring shape.

The beam-shaping waveguiding element can also be tailored to provide an intensity distribution which spatially overlaps not only a ring-shaped Laguerre-Gaussian mode, but also the fundamental mode of the cavity, i.e. the TEM₀₀ mode, so that the cavity lases both on the fundamental mode and a ring-shaped Laguerre-Gaussian mode. The laser beam will then have a profile formed of a mixture of a Gaussian profile and a ring profile, the relative strength of which can be varied, for example to create a top-hat beam profile. Top-hat profiles are desired in some materials processing applications.

A simple technique is thus provided for directly exciting very high quality ring-shaped Laguerre-Gaussian modes with radial, azimuthal or linear polarization, or a combination of one or more Laguerre-Gaussian modes in an optically-end-pumped (non-guided-wave) laser, by using an axially symmetric pump beam with a lower intensity towards the centre of the beam.

The waveguiding element can be conveniently realised as an optical fibre, e.g. a silica glass fibre. Alternatively, a rigid rod can be used, e.g. a rigid glass capillary.

To achieve the beam shaping, the fibre or rod can be fabricated to have a refractive index profile with an outer region with a higher refractive index surrounding an inner region with a lower refractive index, so that the pump beam is guided predominantly in the outer region.

One way of doing this is with a hollow fibre or hollow rod (i.e. capillary), i.e. the outer region is made of a solid material—typically a glass such as a silica glass. The hollow fibre or rod has a hole running axially along the fibre, the hole forming the inner region. In ambient conditions the hole will be filled with air. The hole could also be filled with any other gaseous or liquid medium of suitably low refractive index.

Another way of providing a suitable refractive index profile is with a micro-structured fibre. The fibre's inner region is formed of micro-structured elements that form multiple holes running along the fibre. For example, the micro-structured elements may form a ring of holes between the outer region and a core region.

The design is compatible with Q-switching and mode locking of the resonant cavity. Namely, the resonant cavity may include a Q-switch element. The Q-switch element has variable attenuation properties and may be an externally-controlled variable attenuator or utilize a saturable absorber, as is well known in the art. Moreover, the resonant cavity may include a mode locking element. The mode locking element may be an acousto-optic modulator for active mode-locking or a saturable absorber for passive mode locking, or a non-linear component, as is well known in the art.

Embodiments of the invention thus employ a fibre-based or rod-based beam shaping element with an annular waveguide to re-format the output beam from an optical pump source to yield a pump beam with a substantially axially symmetric transverse intensity distribution with a lower intensity at the centre of the beam in order to produce a population inversion distribution that spatially overlaps the desired axially-symmetric Laguerre-Gaussian mode or modes in the laser gain medium of the resonant cavity, so as to achieve preferential laser oscillation on said mode(s).

The pump source may comprise one or more diode lasers, fibre lasers, solid-state lasers or a combination of these lasers with operating wavelength(s) selected for efficient absorption of the pump laser radiation in the gain medium of the resonant cavity.

The resonant cavity may be a solid-state laser design with a rod, slab or thin disk laser medium geometry doped with a suitable active ion. The active ion may be a rare-earth ion (e.g. Nd, Yb, Er, Tm, Ho, Pr) or a combination of rare earth ions, or another active ion. Alternatively, the resonant cavity may be an optically-pumped semiconductor laser with a thin disk geometry or may be a liquid laser or a gas laser. The resonant cavity can employ a standing-wave or ring resonator architecture, and can be designed to operate in continuous-wave (CW) or high-peak-power pulsed mode of operation.

The pump beam can be coupled into the gain medium of the resonant cavity via an arrangement of one or more lenses. The pump beam can be coupled into the laser gain medium of the cavity in two or more directions to increase the absorbed pump power and hence the output power. A further increase in power may be achieved through provision of two or more laser gain media in the cavity. The output laser beam may be further amplified in power using an amplifier comprising one or more gain elements, pumped in the manner described above, and seeded by a spatially-matched signal beam. The signal beam can be derived from a laser resonator designed to operate on the desired LG mode(s), or via the use of a conventional laser resonator with an external beam shaping element.

The invention provides a laser device comprising: a pump source operable to generate a pump beam; a resonant cavity in which a laser medium is arranged to receive the pump beam and which is operable to output a laser beam; and a beam-shaping element arranged between the pump source and the resonant cavity having a refractive index profile designed to re-shape the pump beam so that the pump beam received by the resonant cavity has an intensity distribution which spatially overlaps a desired ring-shaped Laguerre-Gaussian mode of the resonant cavity sufficiently well to achieve laser oscillation on said desired Laguerre-Gaussian mode.

### BRIEF DESCRIPTION OF THE DRAWINGS

The invention is now described by way of example only with reference to the following drawings.

FIG. 1 shows the basic structure of a first embodiment comprising a pump source, beam conditioning element and resonant cavity.

FIG. 2 shows the pump and fibre beam conditioning element of FIG. 1, in more detail.

FIGS. 3A-3D are schematic illustrations of the transverse cross-section, refractive index profile, near-field pump beam profile and laser beam profile of an example fibre beam conditioning element.

FIGS. 4-4D are schematic illustrations of the transverse cross-section, refractive index profile, near-field pump beam profile and laser beam profile of another example fibre beam conditioning element.

FIG. 5 shows in more detail one example of a scheme for coupling pump light from the pump laser into the fibre beam conditioning element.

FIG. 6 shows in more detail another example of a scheme for coupling pump light from the pump laser into the fibre beam conditioning element.

FIG. 7 shows in more detail a further example of a scheme for coupling pump light from the pump laser into the fibre beam conditioning element.

FIG. 8 shows a second embodiment of the laser device.

FIG. 9 shows a third embodiment of the laser device.

FIG. 10 shows a fourth embodiment of the laser device with an amplifier stage.

FIG. 11A is a schematic structure drawing of a first test device.

FIG. 11B shows the beam profile of the conditioned pump beam at section II of FIG. 11A.

FIGS. 11C, 11D and 11E shows the beam profile of the output laser beam at section III of FIG. 11A

FIG. 11F is a graph of results from the first test device showing how output power (left hand y-axis) and beam quality (right hand y-axis) scales with input power (x-axis).

FIG. 12A is a schematic structure drawing of a second test device.

FIG. 12 shows Me beam profile of the conditioned pump beam at section II of FIG. 12A.

FIGS. 12C, 12D and 12E shows the beam profile of the output laser beam at section III of FIG. 12A for output powers of 0.5, 1.3 and 1.8 W respectively.

FIG. 13A is a schematic structure drawing of a third test device in which the pump beam is split into two components, one of which is passed through a circular fibre and the other of which is passed through a capillary fibre.

FIG. 13B shows at section III of FIG. 13A a pure TEM₀₀ mode generated by pumping solely through the circular fibre

FIG. 13C shows at section III of FIG. 13A a pure LG₀¹ mode generated by pumping solely through the capillary fibre

FIG. 13D shows at section III of FIG. 13A a mixed mode with LG₀¹ or TEM₀₀ components generated by pumping through both the capillary fibre and the circular fibre.

FIG. 13E is a graph of results from the third test device showing how output power (y-axis) scales with input power (x-axis).

FIG. 13F is a graph of results from the third test device plotting intensity to beam radius for each of the three beam forms of FIGS. 13B to 13D.

FIG. 14 is a graph plotting the beam profiles of the fundamental mode and the first three Laguerre Gaussian LG₀^{l} modes.

FIG. 15 is a graph showing which of the LG₀^{l} modes are preferentially excited for which sizes of capillary fibre, where a is the inner air-hole radius of the capillary fibre, b is the outer glass-cladding radius of the capillary fibre and w₀ is the TEM₀₀ mode radius.

FIG. 16A shows schematic structure from a fourth test device.

FIG. 16B is a graph showing experimental results from the Q-switched, fourth test device.

### DETAILED DESCRIPTION

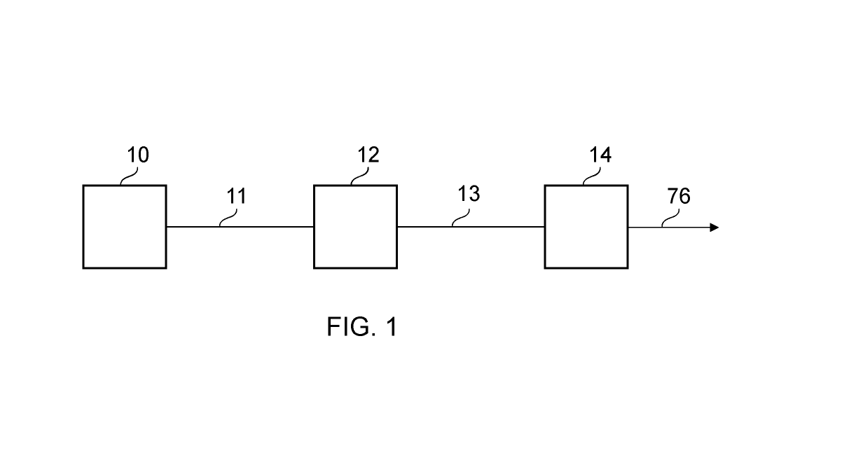

FIG. 1 is a schematic block diagram of a laser device according to a first embodiment. The device comprises a first laser (pump laser) 10 outputting a pump beam 11, a beam conditioning or shaping element 12 for receiving and conditioning the pump beam and outputting a conditioned pump beam 13 and a resonant cavity forming a second laser 14 outputting a laser beam 76. The first laser 10 may be one or more diode lasers, fibre lasers, solid-state lasers or a combination of these lasers with operating wavelength(s) selected for efficient absorption of the first (pump) laser radiation in the gain medium of the second laser. The output beams from the constituent pump lasers are combined using arrangements for free-space optical components and/or optical fibres to provide a single (combined) pump beam delivered, via a free-space delivery scheme or an optical fibre, to the beam conditioning element 12.

The beam conditioning element 12 comprises an optical fibre with at least one annular waveguide for the purpose of re-shaping the pump beam, an optical arrangement for coupling laser radiation from the first laser into the fibre re-shaping element and an optical arrangement for coupling the output from the fibre beam-shaper into the second laser.

The second laser 14 may be a solid-state laser in which the laser medium is a rod, slab or thin disk doped with a suitable active ion. The active on may be a rare-earth ion (e.g. Nd, Yb, Er, Tm, Ho, Pr) or a combination of rare earth ions, or another active ion, so as to produce gain at the desired operating wavelength. Alternatively, the second laser may be an optically-pumped semiconductor laser with a thin disk geometry, or, a liquid or gas laser. The second laser can employ a standing-wave or ring resonator architecture and can be designed to operate in continuous-wave (CW) or high-peak-power pulsed mode of operation. In this scheme, the pump beam provided by the first laser is spatially re-shaped by a fibre-based beam shaping element to yield an axially-symmetric beam profile with lower intensity in the centre of the beam in order to produce a population inversion distribution in the laser gain medium of the second laser that spatially-overlaps the desired Laguerre-Gaussian modes to achieve preferential lasing on these modes.

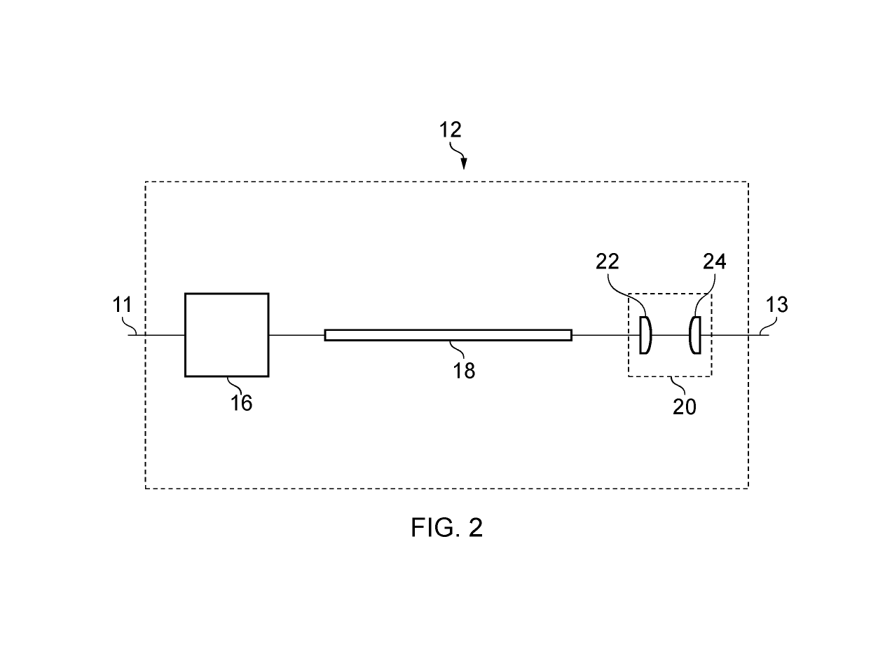

FIG. 2 shows a typical configuration for the fibre beam conditioning device 12, which comprises an optical arrangement 16 for collecting and coupling the pump radiation 11 from the first laser 10 into the beam conditioning fibre 18 and an optical arrangement 20 comprising one or more lenses 22 and 24 for coupling the re-shaped pump beam 13 into the laser medium of the second laser 14 (not shown in this figure). A variant not shown is for pairs of first and second pump lasers 10 and respective fibre beam conditioners 12 to be provided and arranged to couple conditioned pump light 13 into opposite ends of a laser gain medium arranged in the resonant cavity of the second laser to increase the power. A further increase in power may be achieved by employing two or more laser gain media in the second laser, each pumped by one or more pump lasers.

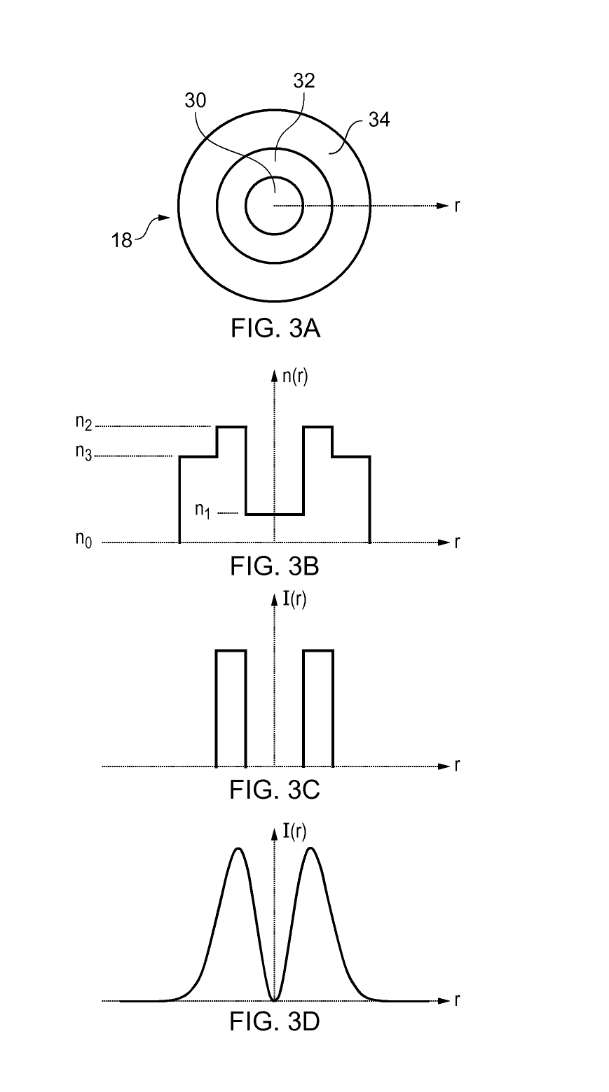

FIGS. 3A-3D show schematically the transverse cross-section, refractive index profile, pump beam profile and laser beam profile of an example fibre beam conditioning element 18.

FIG. 3A shows the transverse cross-section of the fibre which comprises an inner, central region 30 surrounded by an outer, annular waveguide region 32, which itself is surrounded by a cladding region 34. Additionally, the fiber may have a protective outer coating (not shown).

FIG. 3B shows the refractive index profile of the fibre. The inner, central region 30 has an average refractive index n₁. The outer, annular waveguide region 32 has an average refractive index n₂, where n₂>n₁. The cladding region 34 has average refractive index n₃, where n₃<n₂. The baseline refractive index n₀ shown is that of air or a vacuum, i.e. 1. The refractive index profile therefore provides for waveguiding in the annular region 32.

The annular waveguide 32 is preferably multimode with transverse dimensions (i.e. inner radius and outer radius) determined both by the beam parameters of the incoming pump beam (i.e. for efficiently coupling pump light into the annular waveguide 32) and by the final pump beam profile required for selective excitation of the desired Laguerre-Gaussian mode(s) in the second laser. The selective excitation can be facilitated through the choice of resonator design for the second laser and the design of the optical arrangement for coupling pump radiation from the fiber beam shaping element 18 into the second laser.

FIG. 3C shows the axially-symmetric intensity distribution I(r) that results from the annular waveguide's re-shaping of the pump beam. The pump beam profile shown is of course schematic only, since in practice a precise ‘step-like’ profile is not achieved. When pump light enters the annular waveguide 32 of the fibre beam shaping element 18 it excites multiple modes of the annular guide to produce the desired axially-symmetric intensity distribution I(r). In practice, the length of fibre required to achieve the desired beam profile will depend on many factors, including the fibre design and pump launch conditions, but typical lengths are in the range of a few tens-of-centimetres to several metres.

FIG. 3D shows the laser beam profile I(r) which results from the spatially matched pumping and consequent selective lasing of one or more desired LG₀^{l} mode(s).

In one design, the annular waveguide 32 is fabricated from silica glass, the central region 30 is air and the outer region 34 is a low refractive index polymer or fluorine-doped silica glass. In other words, the inner region 30 is a hole and the fibre is a capillary fibre, or a solid glass capillary. The cladding region 34 may also be dispensed with in which case the waveguide would be formed solely by a capillary made of the same glass, i.e. the solid structure would solely consist of the annular glass waveguide 32. Alternatively, the central region 30 may be a low refractive index glass (e.g. fluorine doped silica). More complex axially-symmetric beam profiles as required to select different LG₀¹ modes can be formed if required by using a fibre structure with more than one annular waveguide separated by thin regions of material (e.g. fluorine doped silica) with lower refractive index. In this case, pump light from the first laser can be distributed between the annular waveguides in the manner required by using an appropriate pump coupling scheme 16.

There are many different material and design options for the beam shaper 18, but in all cases the beam shaper has at least one annular waveguide for the purpose of re-shaping the pump beam from the first laser into an axially-symmetric beam with lower intensity at the centre of the beam to spatially overlap one or more Laguerre-Gaussian (LG₀^{l}) modes in the gain medium of the second laser in order to achieve preferential lasing on these modes.

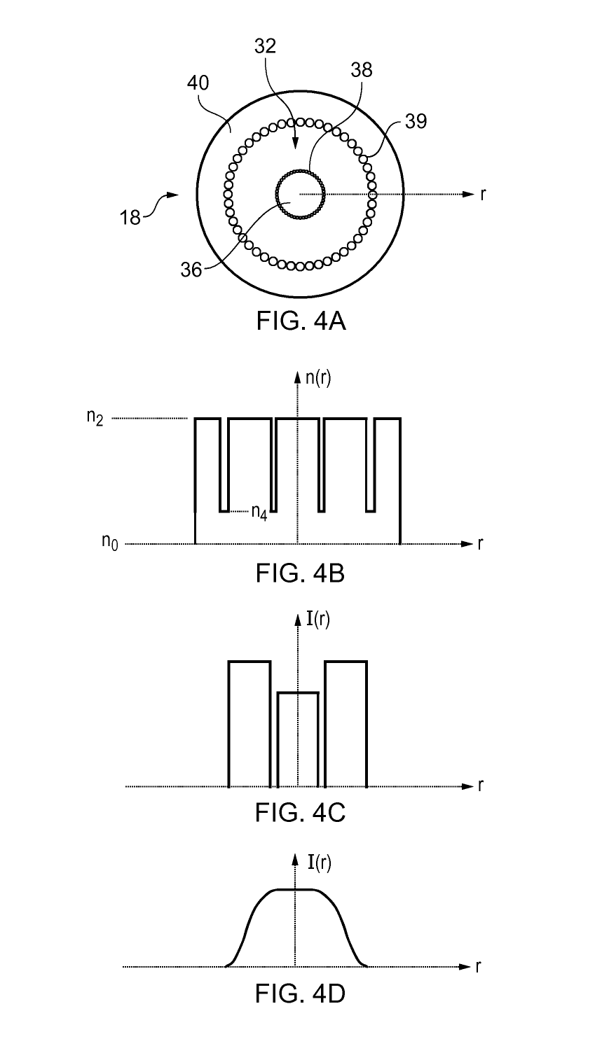

FIGS. 4A-4D show schematically the transverse cross-section, refractive index profile, pump beam profile and laser beam profile of another example fibre beam conditioning element 18.

FIG. 4A shows the transverse cross-section of the fibre. A central solid glass region 36 is surrounded by a ring of micro-structured holes 38 which is then surrounded by an annular region 32 of the same glass as the central region 36 which is then surrounded by a further ring of micro-structured holes 39 which is then surrounded by an annular cladding region 40. The cladding region 40 may be coated with a protective layer (not shown). The holes are filled with air or a different ambient gas.

FIG. 4B shows the refractive index profile of the fibre. The central waveguide 36, annular waveguide 32 and cladding region 40 are each made of the same glass with refractive index n₂. The inner and outer rings of micro-structured air-holes 38 and 39 provide an effective refractive index n₄ intermediate between that of the material in which they are made and air, i.e. n₀<n₄<n₂.

In a variant, the glass, and thus the refractive index of, the annular region 32 ay be different from that of the central region 36—either higher or lower—but with the refractive indices of both regions 32 and 36 being greater than that of the micro-structured hole rings 38 and 39.

The central waveguide 36 and annular waveguide 32 are preferably multimode with transverse dimensions determined both by the beam parameters of the incoming pump beam (i.e. for efficiently coupling pump light into the annular waveguide 32 or, if required, the central waveguide 36 and annular waveguide 32) and by the final pump beam profile required for selective excitation of the desired Laguerre-Gaussian mode(s) in the second laser.

Coupling pump light into both the central waveguide 36 and annular waveguide 32 allows pumping of both the fundamental TEM₀₀ (Gaussian) mode and one or more LG₀ₘ modes of the second laser respectively. The distribution of pump power between the guides can be controlled using the appropriate design of pump coupling scheme 16.

FIG. 4C shows schematically an intensity profile I(r) at the output of the fibre in which the intensity per unit area channeled through the central waveguiding region 36 is somewhat less than that channeled through the annular waveguiding region 32 bounded by the two concentric micro-structured rings of holes 38, 39. The pump beam profile shown is of course schematic only, since in practice a precise ‘step-like’ profile is not achieved.

FIG. 4D schematically shows the laser beam profile that results which has more of a ‘top-hat’-like beam profile as is desirable for certain applications. More generally, the power distribution between the TEM₀₀ and LG₀ₘ modes can he controlled by the pumping both through the design of the refractive index profile of the fibre and how the pump beam is coupled into it so as to yield a combined output beam from the second laser with a desired output pump beam profile.

The fibre regions 32, 36 and 40 can be formed from silica or another suitable glass that has high transmission at the pump wavelength. The lower refractive index regions between 36, 32 and 40 can also be formed using one of more rings of lower refractive index rods instead of air. More complex axially-symmetric beam profiles as required to select different LG₀ₘ modes can be formed if required by using a fibre structure with more than one annular waveguide separated by thin regions with lower refractive index. In this case pump light from the first laser can be distributed between the annular waveguides in the manner required by using an appropriate pump coupling scheme 16.

In a variation of this design, the outer micro-structured ring of holes 39 and cladding 40 of refractive index n₄ could be replaced by a single cladding of refractive index n₃<n₂, i.e. lower than that of the outer region 32, for example n₄<n₃<n₂.

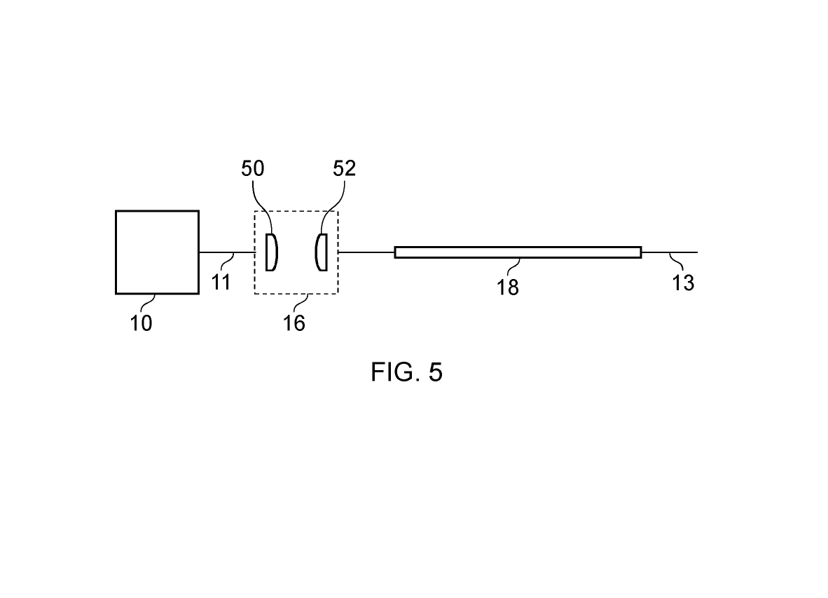

FIG. 5 shows one example of a scheme for coupling pump light 11 from the pump laser 10 into the fibre beam conditioning element 18. A coupling arrangement 16 of one or more lenses 50 and 52 is provided. In this scheme, the pump beam size and position are adjusted to couple pump light efficiently into one or more waveguides in the fibre 18 with the desired power distribution so as to produce the conditioned pump beam 13.

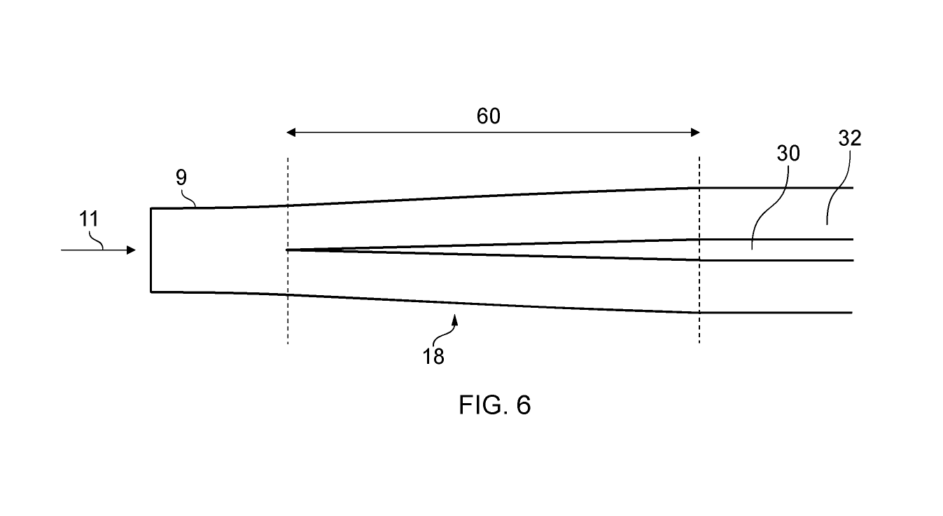

FIG. 6 shows in more detail another example of a scheme for coupling pump light 11 from the pump laser 10 into the fibre beam conditioning element 18. The end 9 of the fibre beam shaping element 18 facing towards the pump laser 10 has no inner region, but rather a uniform refractive index profile provided by the material that forms the outer region 32 in the main body of the fibre 18. Moving along the fibre away from the end 9 that receives the pump beam 11, the structure tapers out and a second material, which forms the inner region 30 in the main body of the fibre 18, appears and gradually increases in diameter over the length of the tapered portion 60. The remainder of the fibre is the same as in the previous embodiment with a constant cross-sectional shape. In this arrangement the beam shaping fiber 18 is tapered to produce a fiber with smaller transverse dimensions at the pump input end to facilitate pump coupling, whilst reducing loss and degradation in pump beam quality. This approach can be very effective with a hollow-core fibre design, since, at the pump input end of the fibre, the hole can be collapsed to form a solid core. This allows for very simple coupling of pump light from the first laser using a simple arrangement of lenses (e.g. as shown in FIG. 5) or by splicing to a multimode pump deliver fibre. The opposite end of the beam shaping fiber 18 is unchanged and hence produces the required ring-shaped pump beam for selective excitation of one or more LG₀^{l} modes in the second laser.

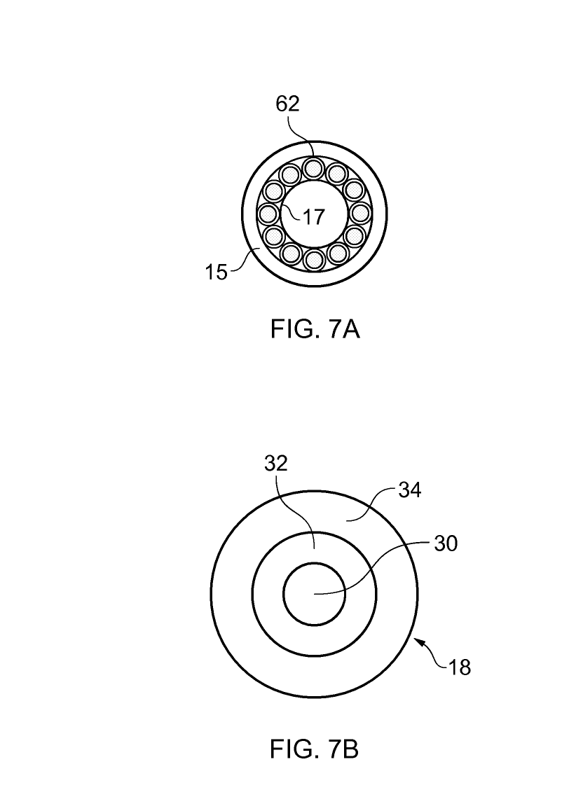

FIG. 7A shows a further example of a scheme for coupling pump light from the pump laser 10 into the fibre beam conditioning element 18. A plurality of pump lasers—twelve in this example have their outputs coupled into respective delivery fibres 62 which are arranged in a ring or annular distribution as illustrated supported by an outer sheath 15 and inner sheath 17. The combined output beam from all the pump lasers is imaged with a suitable arrangement of lenses (not shown) to efficiently couple the pump radiation into the beam shaping element 18.

FIG. 7B is a schematic cross-section of the beam shaping element 18 which is the same as that of FIG. 3, i.e. formed of an annular waveguide 32 of higher refractive index than the adjacent cladding and central regions 34 and 30 respectively. Alternatively, if the fibre dimensions are carefully selected, the bundle of delivery fibres 62 can be spliced directly to the beam shaping fibre 18 to decrease loss and reduce complexity.

There are many other schemes for coupling pump light from the first laser 10 into the beam shaping fibre 18. The coupling methods described above represent only some examples.

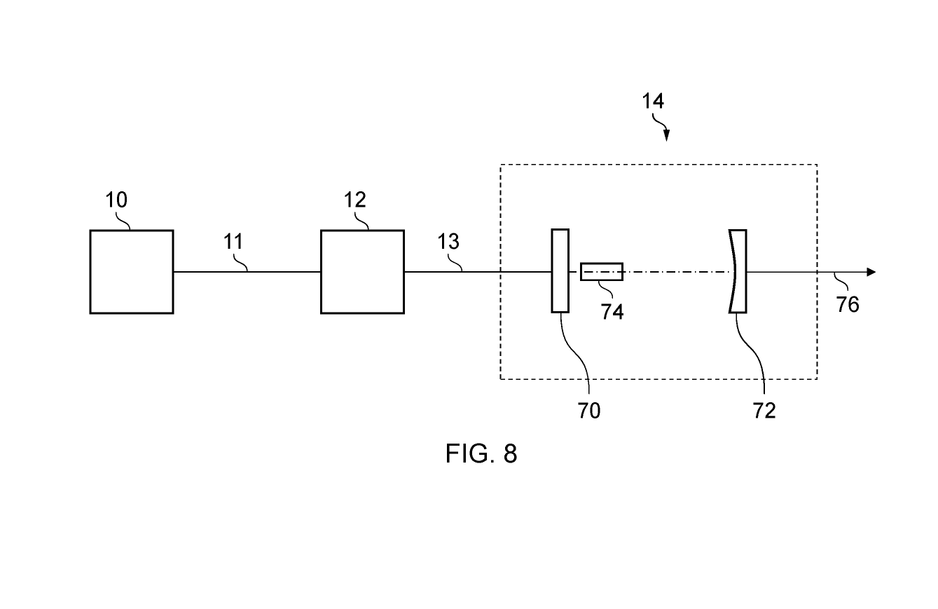

FIG. 8 shows an embodiment of the laser device comprising a first laser (pump laser) 10 outputting a pump beam 11, a beam conditioning or shaping element 12 for receiving and conditioning the pump beam to output a conditioned pump beam 13 and a resonant cavity forming a second laser 14 outputting a laser beam 76. The re-shaped output 13 is used to end pump the second laser 14 with a standing-wave resonator configuration and a laser medium 74. In this example, a simple two-mirror resonator configuration is employed with a plane pump input mirror (input coupler) 70 with high transmission at the pump wavelength and high reflectivity at the lasing wavelength, and with a partially transmitting curved output mirror (output coupler) 72, yielding an output laser beam 76. In this embodiment, pump radiation from the first laser is re-shaped to produce an axially-symmetric beam profile with lower intensity at the centre and this is coupled into the laser medium of the second laser using an appropriate arrangement of lenses to spatially match the desired LG₀^{l} mode or modes in the laser gain medium 74 in order to achieve preferential lasing on the selected mode or modes. The pump beam can be tailored to spatially match the LG₀¹ ring mode to achieve efficient lasing on this mode with a radial, azimuthal or linear output polarization. Alternatively, the pump beam and resonator for the second laser can be configured to achieve lasing on one or more higher order LG₀^{l} modes, or a combination of the TEM₀₀ mode and one or more LG₀^{l} modes.

Added functionality can be achieved by using a modified resonator design with additional active and/or passive components to tailor the dimension of the resonant modes and/or to Q-switch or mode-lock the second laser in order to obtain high-peak-power pulsed output with a tailored output beam profile. The second laser can also be configured as a unidirectional ring laser (e.g. for single longitudinal mode operation)

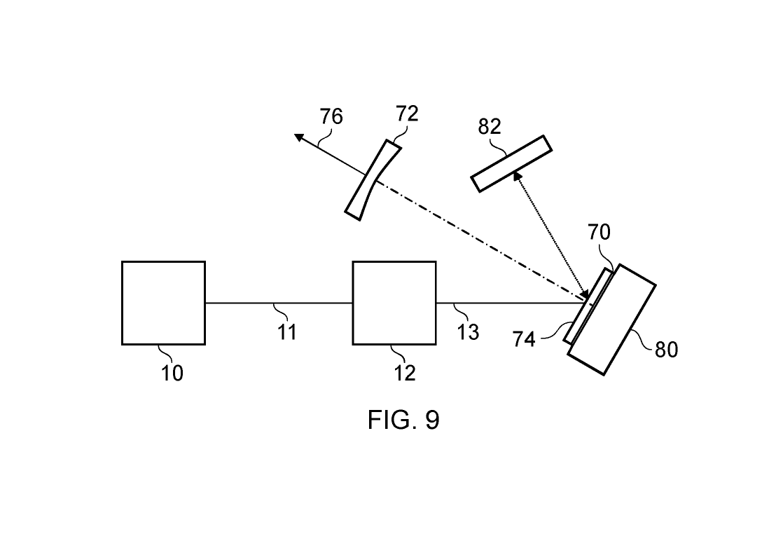

FIG. 9 shows another embodiment of the laser device where the laser medium 74 is in the form of a thin-disk. As illustrated, the laser device comprises a first laser (pump laser) 10 outputting a pump beam 11, a beam conditioning or shaping element 12 for receiving and conditioning the pump beam to output a conditioned pump beam 13. The conditioned pump beam 13 is supplied to the thin-disk laser medium 74 which is backed by a high reflectivity coating 70 which forms one of the cavity mirrors and is attached to a heat-sink 80. The thin-disk laser module is faced by a mirror 72 which forms the other cavity mirror, namely the output coupler from which the output beam 76 emerges.

Thin-disk lasers have a greater degree of immunity to the effects of thermal loading than rod lasers, and hence offer a route to higher output power. In this embodiment, pump light 11 from the first laser 10 is re-shaped by the fibre-based beam conditioner 12 and is incident on the disk laser medium at an angle. Optionally, residual pump light (i.e. pump light not absorbed after a double-pass of the laser medium) can be retro-reflected using a mirror 82 to improve the absorption efficiency. Alternatively, a more complicated multi-pass pumping arrangement can be employed to improve the pump absorption efficiency. Otherwise, the approach for generating axially-symmetric LG₀^{l} modes (or a combination of LG₀^{l} modes) is the same as for the rod laser described in FIG. 8. Once again added flexibility in mode of operation can be achieved with the aid of additional intracavity active and/or passive components to tailor the dimension of the resonant modes and/or to Q-switch and/or ode-lock the laser to produce high-peak-power laser pulses. This approach can be applied, for example, to solid-state and semiconductor laser gain media.

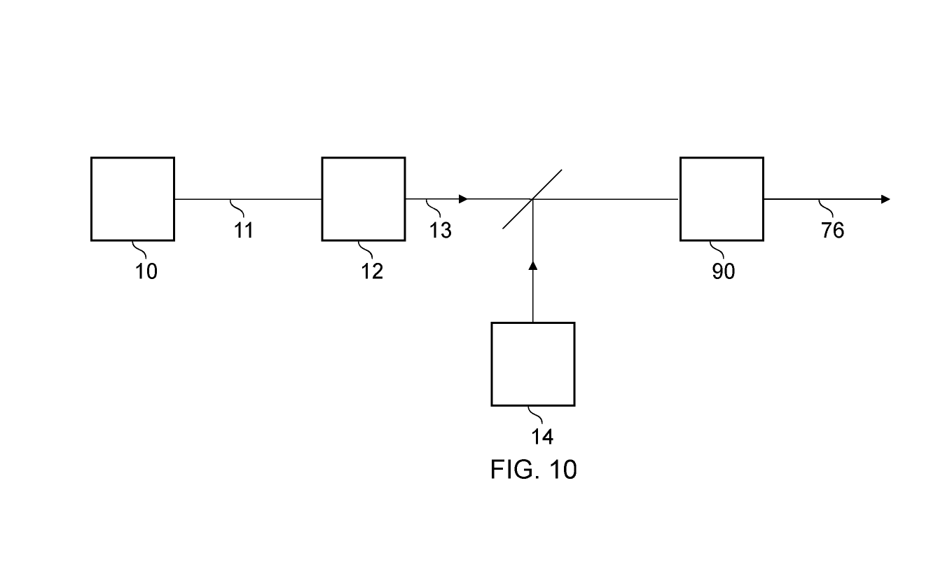

FIG. 10 shows a further embodiment of the invention comprising a first laser (pump laser) 10 outputting a pump beam 11, a beam conditioning or shaping element 12 for receiving and conditioning the pump beam to output a conditioned pump beam 13 and a resonant cavity forming a second laser 14 outputting a laser beam 76. The output from a second laser 14 is amplified using an amplifier 90 comprising one or more gain elements pumped in the manner described above to produce high power output beam 76. In this case, the pump beam provided by the first laser 10 is spatially re-shaped by a fibre-based beam shaping element 12, with at least one annular waveguide, to yield an axially-symmetric beam profile with a lower intensity in the centre of the beam in order to produce a population inversion distribution in the amplifier gain medium that spatially-overlaps the seed laser beam from the second laser 14 to provide preferential amplification of the seed beam. In this way, the output power from the second laser 14 can be amplified to higher power levels than might otherwise be achievable from the second laser. Two or more amplifiers arranged in series may be employed to scale to even higher powers. It should be noted that in this arrangement for scaling laser power, the seed beam can be generated by an alternative laser source employing a different means to generate the desired LG mode(s), or by a more conventional laser with an external beam shaper or mode converter.

Results from several test devices that implement the above designs are now described.

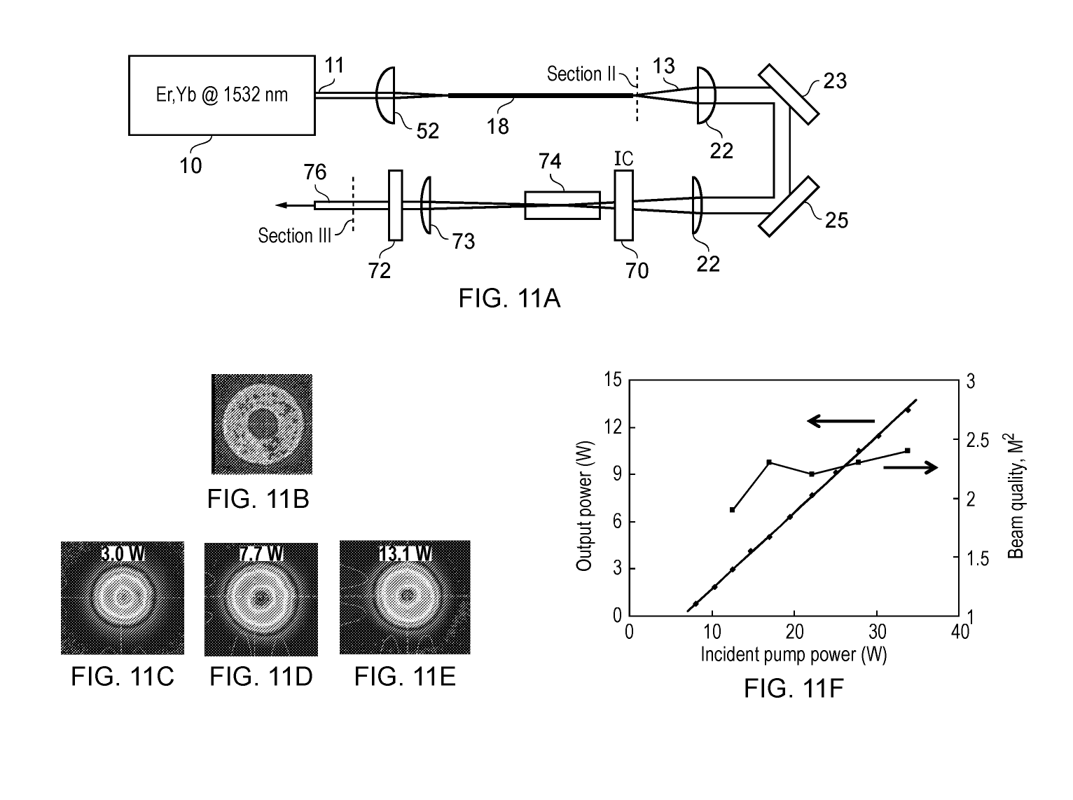

FIGS. 11A-11F show results from a first test device.

In this test device, as illustrated in FIG. 11A, the pump laser 10 is an Er, Yb co-doped fibre laser operating at 1532 nm. The pump beam 11 is coupled via a lens 52 into a capillary fibre 18, which is a fibre with a central axial hole surrounded by an annular region made of a single silica glass compound. The re-shaped pump beam 13 is coupled via a lens 22, two plane mirrors 23 and 25 and a further lens 22 into the resonator cavity formed by the input and output coupler mirrors 70 and 72 respectively which outputs a laser beam 76. The output coupler has a transmissivity of 10%. The cavity contains a laser medium formed for a rod of Erbium-doped Yttrium Aluminium Garnet (0.5% Er:YAG) as well as a lens 73.

FIG. 11 shows the beam profile of the conditioned pump beam 13 at section II of FIG. 11A. The beam quality factor M² of the re-shaped pump beam is approximately 50.

FIGS. 11C, 11D and 11E shows the beam profile of the output laser beam 76 at section III of FIG. 11A. for output powers of 3.0, 7.7 and 13.1 W respectively. The beam quality factor M² of the output beams is less than 2.4. Across the measured range of output powers an axially symmetric, stable and annular beam cross-section was evident.

FIG. 11F is a graph showing how output power (left hand y-axis) and beam quality (right hand y-axis) scales with input power (x-axis). The so-called slope efficiency, i.e. the rate of increase of output power with respect to input pump power, is linear and is around 48%. The beam quality M² lies between about 2 and 2.5.

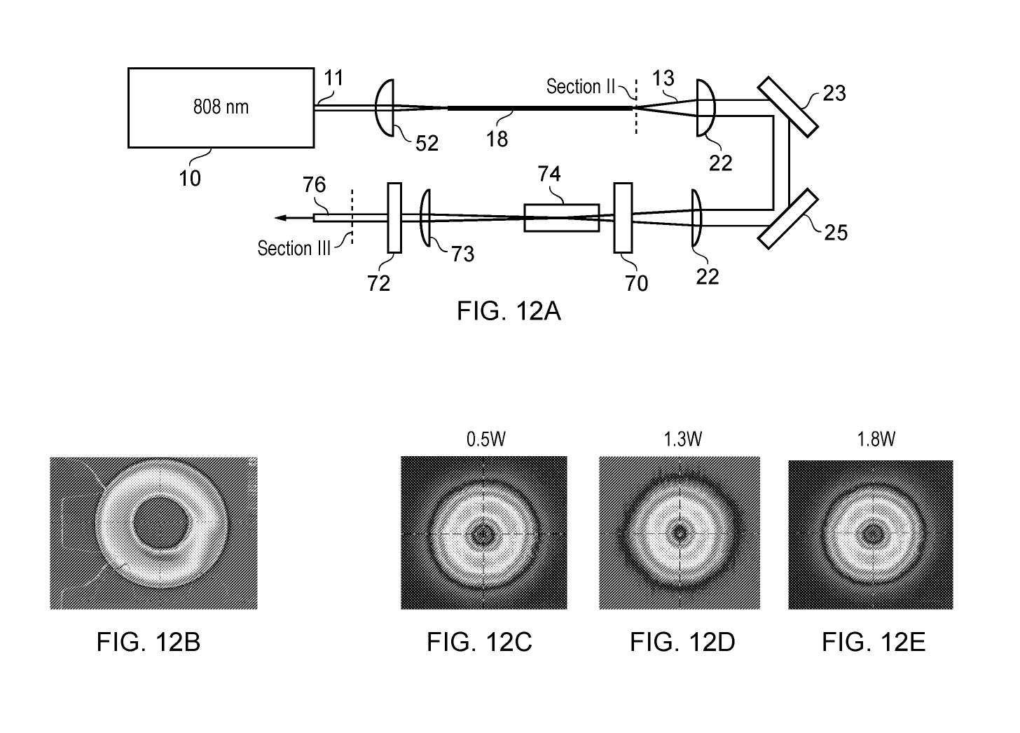

FIGS. 12A-12E show results from a second test device.

In this test device, as illustrated in FIG. 12A, the pump laser 10 is a GaAlAs semiconductor diode laser operating at 808 nm. The pump beam 11 is coupled via a lens 52 into a capillary fibre 18. The re-shaped pump beam 13 is coupled via a lens 22, two plane mirrors 23 and 25 and a further lens 22 into the resonator cavity formed by the input and output coupler mirrors 70 and 72 respectively which outputs a laser beam 76. The output coupler has a transmissivity of 10%. The cavity contains a laser medium formed for a crystal rod neodymium-doped yttrium aluminium garnet (Nd:YAG). The cavity also includes a lens 73. An alternative crystal for the rod would be neodynium-doped yttrium aluminium vanadate (Nd:YVO₄).

FIG. 12B shows the beam profile of the conditioned pump beam 13 at section II of FIG. 12A. The beam quality factor M² of the re-shaped pump beam is more than 400.

FIGS. 12C, 12D and 12E shows the beam profile of the output laser beam 76 at section III of FIG. 12A for output powers of 0.5, 1.3 and 1.8 W respectively. The beam quality factor M² of the output beams is about 2. Across the measured range of output powers an axially symmetric, stable and annular beam cross-section was evident.

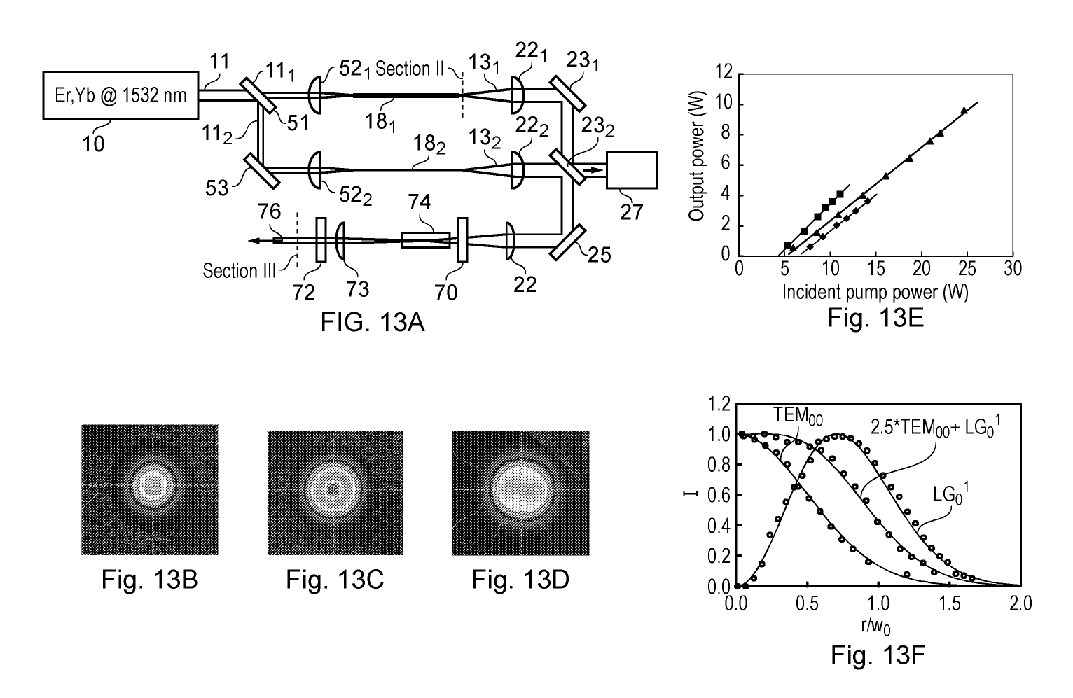

FIGS. 13A-13F show results from a third test device which may be viewed as an adaptation of the first test device in which a circular-section fibre has been added in parallel with the capillary fibre.

In this test device, as illustrated in FIG. 13A, the pump laser 10 is an Er, Yb co-doped fibre laser operating at 1532 nm. The pump beam 11 is split into equal power components 11₁ and 11₂ by a 50% transmissivity mirror 51.

The first pump beam component 11₁ follows the same path as in the first test device, namely is coupled via a lens 52₁ into a capillary fibre 18₁ in which it is re-shaped and then output as pump beam component 13₁, coupled via a lens 22₁, and a plane mirrors 23, towards a further plane mirror 25.

The second pump beam component 11₂ is redirected by a plane mirror 53 and then coupled via a lens 52₂ into a conventional multimode circular-section fibre 18₂ from which it is output as pump beam component 13₂, coupled via a lens 22₂, and a plane mirror 23₂ of 50% transmissivity.

The first and second pump beam components 11₁ and 11₂ are recombined at semi-transparent mirror 23₂ and are then directed via plane mirror 25 and a further lens 24 into the resonator cavity formed by the input and output coupler mirrors 70 and 72 respectively which outputs a laser beam 76. The output coupler has a transmissivity of 10%. The cavity contains a laser medium formed for a rod of Erbium-doped Yttrium Aluminium Garnet (0.5% Er:YAG) as well as a lens 73. A power meter 27 is also shown adjacent mirror 23₂ which was used during testing to assist correct re-combination of the two pump beam components.

The purpose of splitting the pump beam into two and conditioning the two components in a capillary and circular fibre respectively is to simulate the effect of a conditioning fibre such as described in relation to FIG. 4, since the capillary fibre is designed to selectively excite the cavity's LG₀¹ mode, thereby fulfilling the role of the annular waveguide, and the circular fibre is designed to excite the fundamental mode (TEM₀₀), thereby fulfilling the role of the central waveguide.

FIGS. 13B, 13C and 13D shows the beam profile of the output laser beam 76 at section III of FIG. 13A for:
a pure TEM₀₀ mode generated by pumping solely through the circular fibre 18₂ (FIG. 13B) thereby to generate a Gaussian beam
a pure LG₀¹ mode generated by pumping solely through the capillary fibre 18₁ (FIG. 13C) thereby to generate a hollow beam
a mixed mode with LG₀¹ or TEM₀₀ components generated by pumping through both the capillary fibre 18₁ and the circular fibre 18₂ (FIG. 13D) thereby to generate a top-hat beam. The mixture was 2.5*TEM₀₀+LG₀¹.

FIG. 13E is a graph showing how output power (y-axis) scales with input power (x-axis). The results for the Gaussian beam, hollow beam and mixed top-hat beam are shown with squares, diamonds and triangles respectively. The so-called slope efficiency, i.e. the ratio of output power to input power, is 60%, 47% and 49% for the Gaussian beam, hollow beam and mixed top-hat beam respectively.

FIG. 13F is a graph plotting intensity (normalised) to beam radius (normalised to Gaussian beam waist radius w or w₀) for each of the three beam forms. As expected, the TEM₀₀ beam shows a Gaussian distribution and the LG₀¹ beam shows a clear peak offset from zero characteristic of its ring or doughnut shape. The mixed beam 2.5*TEM₀₀+LG₀¹ as desired shows a broader, flattish peak intensity over a range of radii from zero to around 0.5, i.e. a top-hat shape, rather than the immediate drop in intensity away from the centre of the beam demonstrated by the Gaussian TEM₀₀ beam. The much broader peak-intensity area of the top-hat beam compared with the Gaussian beam is also evident from a visual comparison of FIGS. 13B and 13D. These results show that the top-hat shape produced by the test device correspond to what is shown schematically in FIG. 4D.

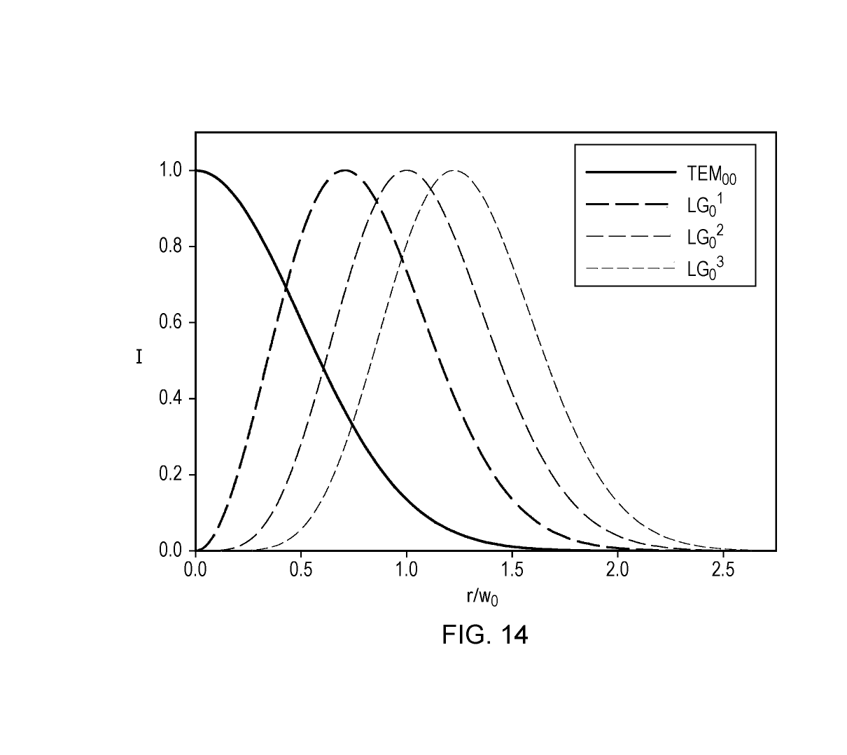

FIG. 14 is a graph plotting the beam profiles of the fundamental mode and the first three Laguerre Gaussian LG₀^{l} modes, i.e. the modes TEM₀₀ LG₀¹ LG₀² and LG₀³. Intensity (normalised) is plotted against beam radius (normalised to Gaussian beam waist radius w or w₀) for each of the beam forms. As can be seen the peak intensity of each of the LG₀^{l} modes moves to higher radii as the order increases. The graph illustrates how it is feasible to excite a targeted LGₒₘ mode selectively by controlling the parameters of a capillary fibre or other beam shaping waveguide with a tailored refractive index profile.

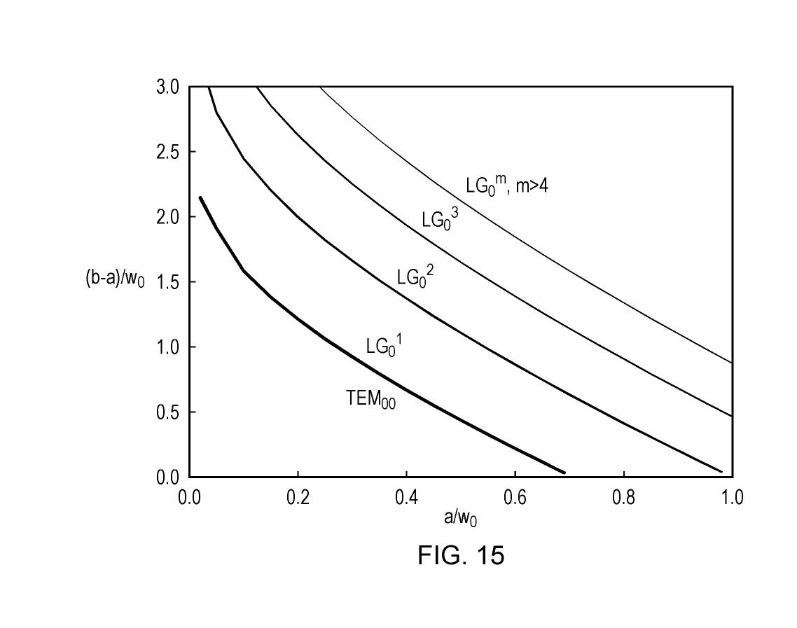

FIG. 15 is a graph showing which of the LG₀^{l} modes are preferentially excited for which sizes of capillary fibre, where a is the inner air-hole radius of the capillary fibre, b is the: outer glass-cladding radius of the capillary fibre and w₀ is the TEM₀₀ mode radius. The y-axis is the normalised ring thickness (b−a)/w₀ and the x-axis is normalised hole size a/w₀. In this calculation the pump beam exiting the capillary fibre is assumed to have a ‘step-like’ intensity profile that matches the dimensions of the annular waveguide.

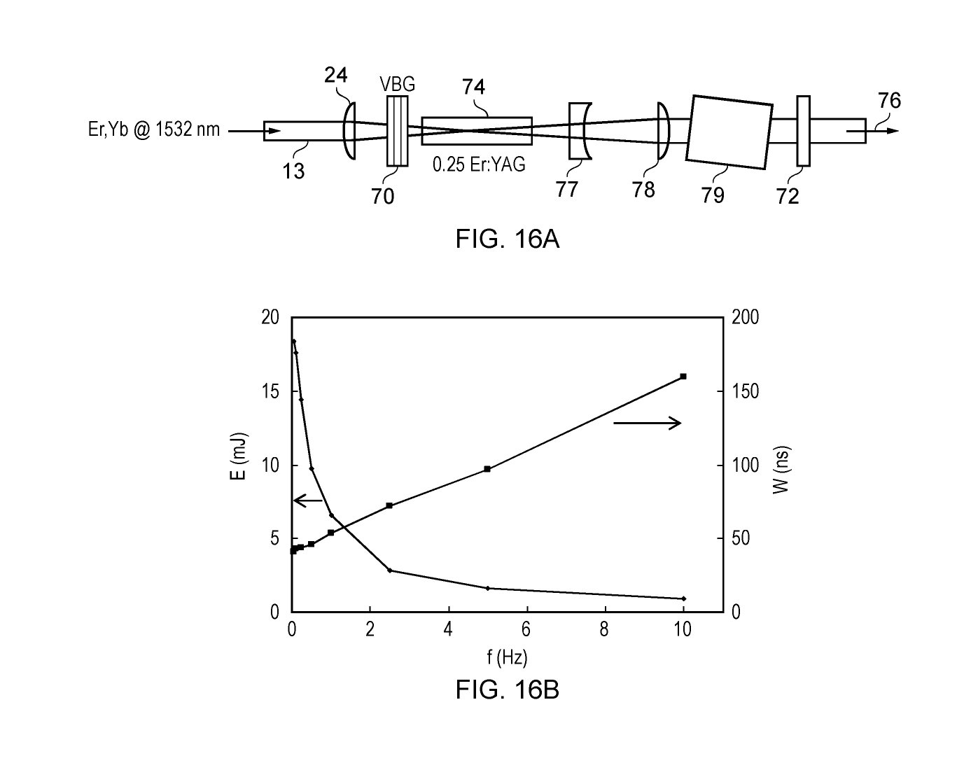

FIG. 16A shows schematic structure of a fourth test device. An erbium-ytterbium co-doped fibre laser is used as the pump laser (not shown) outputting a pump beam at 1532 nm, which is re-shaped by a capillary fibre (not shown) into an annular pump beam 13 which is coupled by a lens 24 into a laser cavity formed by input and output couplers 70, 72. The input coupler 70 is a volume Bragg grating (VBG). The output coupler is a conventional semi-transparent mirror with a transmissivity of 20%. The laser medium 74 is a rod of 0.25% Er:YAG crystal. For Q-switching, an acousto-optic modulator 79 is arranged in the cavity. The cavity also includes further lenses 77 and 78. A pulsed output beam 76 is thereby produced.

FIG. 16B is a graph showing experimental results from the Q-switched, fourth test device. Pulse energy E in mJ (left hand y-axis) and pulse width W in ns (right hand y-axis) are plotted as a function of repetition rate, f in Hz. Average power Pav=10.2 W for 48 W of fibre laser pump (<3× threshold) and high repetition rates. Maximum pulse energies were ˜18.4 mJ with 42 ns pulse width at a 50 Hz repetition rate. The power achieved during the tests were limited by the available pump power. We have thus demonstrated direct Q-switched laser operation of an LG mode.

Lasers embodying the invention may be used for many applications where it is necessary to have a laser beam with a tailored intensity profile at some desired location(s), examples include hollow laser beams for manipulation of very small objects³⁰, and top-hat or doughnut beams used in laser materials processing such as ablation, machining, drilling or welding³¹. Specific example applications are: optical tweezers; optical trapping, guiding and manipulation of atoms; extreme ultraviolet lithography; and LG₀¹ beam microscopy.

The required intensity distributions can be generated through the manipulation of the laser beam phase-front, or by the superposition of selected higher-order modes, as described above. Moreover LG modes exhibit unique polarization properties, such as radial, azimuthal polarization, in addition to linear polarization states, and can be configured to have optical orbital momentum²⁴. The combination of a tailored intensity distribution and polarization state can enhance the performance of many applications involving light-matter interaction, at the same time enabling new ones to be discovered.

In the above embodiments, the pump beam is spatially re-shaped by a fibre-based beam shaping element with at least one annular waveguide to yield an axially-symmetric beam profile with a lower intensity in the centre of the beam in order to produce a population inversion distribution in the laser gain medium of the resonant cavity that spatially-overlaps the desired Laguerre-Gaussian mode or modes, so as to yield preferential lasing or amplification of said mode(s).

Using this approach, the pump beam can be re-shaped into an axially-symmetric ring-shaped pump beam in the near-field to allow preferential excitation in the resonant cavity of a single Laguerre-Gaussian mode (e.g. LG₀¹, LG₀² or a higher-order mode) with a ring-shaped near-field and far-field intensity distribution. Additionally, the laser may be configured to operate with radial, azimuthal or linear output polarisation as required by the application.

As described, the pump beam may be re-shaped using a specially designed fibre-based beam shaping element to yield a tailored pump beam to allow preferential lasing in the second laser on two (or more) axially-symmetric transverse modes (e.g. TEM₀₀ and LG₀¹) for the purpose of generating an output beam with a more ‘top-hat’-like near-field and far-field beam profile with very good beam quality.

The technique is extremely simple and low cost to realise, since the only custom element is the pump beam conditioning element which can be fabricated easily out of fibre, such as silica fibre, or optionally thin rod, such as a glass capillary. References to silica fibre mean silica-based fibre, not pure silica fibre, so include the broader family of silica glasses based on alloys of silica including, for example, borosilicate, fluorosilicate and phosphosilicate glasses.

As described, various low-index-core, hollow-core, or micro-structured fibre designs are possible for achieving a sufficiently high degree of spatial overlap with the desired mode(s) in order to achieve preferential lasing on those modes.

The above approach for selective excitation of one or more axially-symmetric LG₀^{l} modes can provide low-loss, high efficiency and flexibility compared to prior art approaches. Moreover, the technique is compatible with power scalable laser architectures and hence offers a route to very high average power in continuous-wave and pulsed mode of operation serving the needs of a range of applications.

### REFERENCES

1. I. Manek, Y. B. Ovchinnikov and R. Grimm, Opt. Commun. 147 (1-3), 67-70 (1998).

2. J. P. Yin and Y. F. Zhu, Journal of Applied Physics 85 (5), 2473-2481 (1999).

3. M. W. Beijersbergen, L. Allen, H. Vanderveen and J. P. Woerdman, Opt. Commun. 96 (1-3), 123-132 (1993).

4. N. Passilly, R. de Saint Denis, K. Ait-Ameur, F. Treussart, R. Hierle and J. F. O. Roch, J. Opt. Soc. Am. A-Opt. Image Sci. Vis. 22 (5), 984-991 (2005).

5. M. W. Beijersbergen, R. P. C. Coerwinkel, M. Kristensen and J. P. Woerdman, Opt. Commun. 112 (5-6), 321-327 (1994).

6. G. Machavariani, N. Davidson, E. Hasman, S. Blit, A. A. Ishaaya and A. A. Friesem, Opt. Commun. 209 (4-6), 265-271 (2002).

7. G. Machavariani, Y. Lumer, I. Moshe, A. Meir and S. Jacket, Optics Letters 32 (11), 1468-1470 (2007).

8. N. R. Heckenberg, R. McDuff, C. P. Smith, H. Rubinszteindunlop and M. J. Wegener, Opt. Quantum Electron. 24 (9), S951-S962 (1992).

9. J. Arlt, K. Dholakia, L. Allen and M. J. Padgett, J. Mod. Opt. 45 (6), 1231-1237 (1998).

10. Maurer, A. Jesacher, S. Furhapter, S. Bernet and M. Ritsch-Marte, New J. Phys. 9 (2007).

11. M. Staider and M. Schadt, Optics Letters 21 (23), 1948-1950 (1996).

12. S. A. Kennedy, M. J. Szabo, H. Teslow, J. Z. Porterfield and E. R. I. Abraham, Phys. Rev. A 66 (4) (2002).

13. S. C. Chu, T. Ohtomo and K. Otsuka, Applied Optics 47 (14), 2583-2591 (2008).

14. M. Okida and T. Omatsu, Optics Express 15 (12), 7616-7622 (2007).

15. Y. Kozawa, K. Yonezawa and S. Sato, Applied Physics B-Lasers and Optics 88 (1), 43-46 (2007).

16. I. Moshe, S. Jackel and A. Meir, Optics Letters 28 (10), 807-809 (2003).

17. G. Machavariani, Y. Lumer, I. Moshe, A. Meir, S. Jackel and N. Davidson, Applied Optics 46 (16), 3304-3310 (2007).

18. M. Harris, C. A. Hill, P. R. Tapster and J. M. Vaughan, Phys. Rev. A 49 (4), 3119-3122 (1994).

19. Y. Kozawa and S. Sato, Optics Letters 30 (22), 3063-3065 (2005).

20. M. A. Ahmed, A. Voss, M. M. Vogel and T. Graf, Optics Letters 32 (22), 3272-3274 (2007).

21. M. A. Ahmed, J. Schulz, A. Voss, O. Parriaux, J. C. Pommier and T. Graf, Optics Letters 32 (13), 1824-1826 (2007).

22. Y. F. Chen, Y. P. Lan and S. C. Wang, Applied Physics-Lasers and Optics 72 (2), 167-170 (2001).

23. J. E. Bisson, Y. Senatsky and K. I. Ueda, Laser Phys. Lett. 2 (7), 327-333 (2005).

24. L. Allen, M. W. Beijersbergen, R. J. C. Spreeuw and J. P. Woerdman, Phys. Rev. A, At. Mol. Opt. Phys. 45 (11), 6 (1992).

25. N. Lindlein, G. Leuchs and S. Ramachandran, Applied Optics 46 (22), 5147-5157 (2007).

26. S. Ramachandran, P. Kristensen and M. F. Yan, Optics Letters 34 (16), 2525-2527 (2009).

27. M. Fridman, G. Machavariani, N. Davidson and A. A. Friesem, Applied Physics Letters 93 (19) (2008).

28. T. Grosjean, A. Sabac and D. Courjon, Opt. Commun. 252 (1-3), 12-21 (2005).

29. T. Hirayama, Y. Kozawa, T. Nakamura and S. Sato, Optics Express 14 (26), 12839-12845 (2006).

30. J. Arlt and M. J. Padgett, Optics Letters 25 (4), 191-193 (2000).

31. M. Meier, V. Romano and T. Feurer, Appl. Phys. A-Mater. Sci. Process. 86 (3), 329-334 (2007).

What is claimed is:

1. A laser device comprising:
a pump source operable to generate a pump beam;
a waveguiding element having a first end arranged to receive the pump beam and a second end to output the pump beam after traversing the waveguiding element; and
a resonant cavity in which a laser medium is arranged to receive the pump beam output from the waveguiding element and which is operable to output a laser beam,
characterised in that
the waveguding element has a refractive index profile designed to re-shape the pump beam so that the pump beam output from the waveguiding element has an intensity distribution which spatially overlaps a desired ring-shaped Laguerre-Gaussian mode of the resonant cavity sufficiently well to achieve laser oscillation on said desired Laguerre-Gaussian mode.

2. The device of claim 1, wherein the waveguiding element has a refractive index profile with an outer region with a higher refractive index surrounding an inner region with a lower refractive index such that the pump beam is guided predominantly in the outer region.

3. The device of claim 1 or 2, wherein the waveguiding element has a capillary structure with the outer region being made of a solid material which forms a hole running axially along the waveguiding element, the hole forming the inner region.

4. The device of claim 1 or 2, wherein the inner region is formed of micro-structured elements that form multiple holes running along the waveguiding element.

5. The device of any preceding claim, wherein the intensity distribution spatially overlaps a further desired ring-shaped Laguerre-Gaussian mode of the resonant cavity sufficiently well to achieve laser oscillation also on said further desired Laguerre-Gaussian mode.

6. The device of any preceding claim, wherein the intensity distribution spatially overlaps the fundamental mode of the resonant cavity sufficiently well to achieve laser oscillation also on said fundamental mode.

7. The device of any preceding claim, wherein the resonant cavity includes a Q-switch element.

8. The device of any preceding claim, wherein the resonant cavity includes a mode locking element.

9. The device of any of claims 1 to 8, wherein the waveguiding element is formed of a fibre.

10. The device of any of claims 1 to 8, wherein the waveguiding element is formed of a rod.
